(19) United States
(12) Patent Application Publication
(10) Pub. No.: US 2010/0231600 A1
(43) Pub. Date: Sep. 16, 2010

(54) HIGH BANDWIDTH, EFFICIENT GRAPHICS HARDWARE ARCHITECTURE

(75) Inventors: Shachar Chaim Kaufman, Petach-Tiqwa (IL); Gedalia Oxman, Tel Aviv (IL); Nir Darshan, Petach-Tiqua (IL)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(73) Assignee: HORIZON SEMICONDUCTORS LTD., Herzliya (IL)

(21) Appl. No.: 12/401,870

(22) Filed: Mar. 11, 2009

(51) Int. Cl. G09G 5/36

(52) U.S. Cl. 345/545

(57) ABSTRACT

The present invention relates to a system according to claim 1, where the pixel buffer cache comprises at least one row descriptor for tracking and monitoring the activities of read and write requests of a particular tile. A system for providing a high bandwidth memory access to a graphics processor comprising: (a) a frame buffer for storing at least one frame, where said frame is stored in a tiled manner; (b) a memory controller for controlling said frame buffer; (c) a pixel buffer cache for storing multiple sections of at least one memory row of said frame buffer, and for processing requests to access pixels of said frame buffer; (d) a graphics accelerator having an interface to said pixel buffer cache for processing a group of related pixels; and (e) a CPU for processing graphic commands and controlling said graphics accelerator and said pixel buffer cache.

### FIELD OF THE INVENTION

The present invention relates to the field of graphics processing hardware architectures. More particularly, the invention relates to a method and system for providing a graphics processor with a high bandwidth access to a memory shared by other processors.

### BACKGROUND OF THE INVENTION

The field of Digital TV (DTV) applications has generated a great deal of interest from consumers and providers for the past two decades. Many households have adopted a digital cable or satellite Set-Top Box (STB) for streaming encoded video and other multimedia contents. As the technology of digital STBs and media players develops, the requirement for a more engrossing user experience is also expanding. Today's broadcasting and recording standards provide advanced studio-quality image composition, 3D graphics, complex and dynamic menus and subtitles, as apposed to previous TV broadcast contents which provided a simple menu system and basic subtitles.

Initially, the Graphic Processing Unit (GPU) was intended for high-end and ultra-expensive graphics workstations, mainly used by studios and labs. With the development of silicon fabrication processes, GPUs started to appear in high-end gaming consoles and PCs, and eventually in mainstream varieties of such devices. On the other hand, another brand of GPUs has also been developed—cheaper, smaller and power conserving for enabling sufficient graphics on hand-held devices such as cellular phones and PDAs.

Somewhere in between these two markets—the professional high-end graphics market and the portable low-end graphics market is the third and rapidly developing market of embedded System On Chip (SOC) for various purposes (e.g. DTV and digital media equipment). On the one hand, mainstream GPUs are usually large, expensive, and require a tremendous amount of power to operate (which also makes cooling a concern), and on the other hand, low-end and mobile GPUs are substantially limited and are intended for small resolution screens. For a commonplace STB distributed free of charge or at a minimal cost to a very large base of operator subscribers, or for a media player on sale for less than the cost of a toaster, it is imperative that an embedded GPU be extremely cheap to manufacture and have reasonable heat dissipation while at the same time be able to produce high level graphics as expected by today's users for driving a High Definition (HD) TV screen.

A typical multimedia SOC integrates processors, caches, video and audio codecs, 2d & 3d graphics, and various connectivity interfaces (networking, USB, etc) into a single chip. Therefore, in order to reduce system cost and in order to ease data sharing between the various integrated components, unified memory architecture is usually utilized, in which the various processing units share an external big storage memory such as DDR.

Memory bandwidth is the predominant performance per Watt limiting factor in graphics applications, due to the constantly increasing resolutions and frame rates. In the case of a SOC, an integrated graphics processing unit is competing for memory bandwidth with other processing units such as video codecs, and therefore a method of increasing the efficiency of memory bandwidth usage is highly desirable.

One of the known methods for increasing memory bandwidth is the use of a cache memory. Cache memories generally improve memory access speeds in computer or other processing systems, thereby typically improving overall system performance. Increasing either or both of cache size and speed tend to improve system performance, thereby using larger and faster caches is generally desirable. However, cache memory is often expensive, and typically its cost rises as its required speed and size increase. Therefore, the selection of the cache to be used needs to be balanced with overall system cost, and an efficient method is necessary for utilizing the cache memory advantageously.

U.S. Pat. No. 6,674,443 discloses a system and method for accelerating graphics operations. The described system includes a memory device for accelerating graphics operations within an electronic device. A memory controller is used for controlling pixel data transmitted to and from the memory device. A cache memory is electrically coupled to the memory controller and is dynamically configurable to a selected usable size to exchange an amount of pixel data having the selected usable size with the memory controller. A graphics engine is electrically coupled to the cache memory, which stores pixel data, generally forming a two-dimensional image in a tiled configuration. The cache memory may also comprise a plurality of usable memory areas or tiles. The disclosed invention also includes a method for accelerating graphics operations within an electronic device. The method includes receiving a request for accessing data relating to a pixel. A determination is made as to which pseudo tile the pixel is located. The pseudo tile is selectively retrieved from a memory device and stored in a cache memory in a tile configuration. The requested pixel data is provided from the cache memory, which contains at least one tile.

Nevertheless, the described memory is not arranged in a full two dimensional tile configuration method which increases memory access speed of graphics operations.

It is an object of the present invention to provide a method for supplying a graphics processor with a high bandwidth access to a memory.

It is another object of the present invention to provide a SOC with a graphics processor having a high bandwidth access to a memory shared by other processors of the SOC.

It is still another object of the present invention to provide a method for efficiently arranging a shared memory for storing graphics data.

It is still another object of the present invention to provide a method for efficiently utilizing a cache of a graphics processor.

It is still another object of the present invention to provide a method for accelerating the processing of graphics commands.

It is still another object of the present invention to provide a system that distributes the graphics processing tasks more efficiently between the processing units of the SOC.

Other objects and advantages of the invention will become apparent as the description proceeds.

### SUMMARY OF THE INVENTION

The present invention relates to a system according to claim 1, where the pixel buffer cache comprises at least one row descriptor for tracking and monitoring the activities of read and write requests of a particular tile. A system for providing a high bandwidth memory access to a graphics processor comprising: (a) a frame buffer for storing at least one frame, where said frame is stored in a tiled manner; (b) a memory controller for controlling said frame buffer; (c) a pixel buffer cache for storing multiple sections of at least one memory row of said frame buffer, and for processing requests to access pixels of said frame buffer; (d) a graphics accelerator having an interface to said pixel buffer cache for processing a group of related pixels; and (e) a CPU for processing graphic commands and controlling said graphics accelerator and said pixel buffer cache.

Preferably, the pixel buffer cache comprises at least one row descriptor for tracking and monitoring the activities of read and write requests of a particular tile.

Preferably, the pixel buffer cache comprises an internal memory which can store at least one tile.

Preferably, the pixel buffer cache comprises at least one read daemon which reads pixels from the frame buffer and writes them into the internal memory.

Preferably, the pixel buffer cache comprises at least one sync daemon which finds the modified pixels in the internal memory and writes them into the frame buffer.

Preferably, the graphics accelerator contains one or more line buffers for storing pixels.

Preferably, each line buffer contains pixel memories and a control memory.

Preferably, the graphics accelerator contains at least one DMA machine which transfers data between the line buffers and the pixel buffer cache.

Preferably, the graphics accelerator contains a programmable micro-control unit.

Preferably, the programmable micro-control unit performs vector graphics operations.

Preferably, the graphics accelerator contains dedicated hardware for line drawing.

The present invention also relates to a method for optimizing memory bandwidth to a graphics processor comprising the steps of (a) receiving a request for rendering a geometric object; (b) dividing said request for geometric object into multiple burst requests; (c) transferring said burst requests to the pixel buffer cache; (d) calculating the address of the row of said pixel; (e) checking if said row is present in the pixel buffer cache; (f) activating row reclaim process if said row is not present in said pixel buffer cache; and (g) activating at least one daemon for transferring data between the internal memories of said pixel buffer cache and the frame buffer.

### BRIEF DESCRIPTION OF THE DRAWINGS

In the drawings:

FIG. 1 is a simplified block diagram of a graphics processor according to an embodiment of the invention.

FIG. 2 schematically illustrates an example for the mapping of a frame having 512×512 pixels into 4 memory banks.

FIG. 3 is a flow chart depicting the process of the Pixel Buffer Cache for accessing a pixel.

FIG. 4 is a block diagram of the inner parts of the Pixel Buffer Cache.

### DETAILED DESCRIPTION OF PREFERRED EMBODIMENTS

### Terms Definitions

For the sake of brevity the following terms are defined explicitly:

Pixel—a picture element, which is the smallest item of information in a frame. Pixels are normally arranged in a 2-dimensional grid. The terms pixel and pixel values are used interchangeably. In the following description a pixel consists of 4 bytes of information: Red, Green, Blue, and Alpha.

Bank—a memory module for storing data including pixel values. For the following description a single data interface is assumed for all the memory banks.

Burst—a burst is the smallest address accessible data portion in the memory, i.e. in an “atomic” manner. In the following description a burst stores 8 adjacent horizontal pixels.

Row—a logical quantity of data within the bank, having an accessible address, for storing a number of adjoining bursts. The adjoining bursts of a row may be accessed without additional access memory module penalty. Rows in parallel banks can be activated and precharged simultaneously. For the following description a row can store a total number of 512 pixels.

Tile—a 2 dimensional array of pixels. For the following description a tile is a 2 dimensional array of pixels in a frame and contains 8×8 bursts, altogether 512 pixels (=64×8 pixels), which can be stored in a single row.

Frame Buffer (FB)—a number of rows in a number of memory banks allocated together which can store together one or more frames. For the following description the FB consist of 4 banks.

### Overview

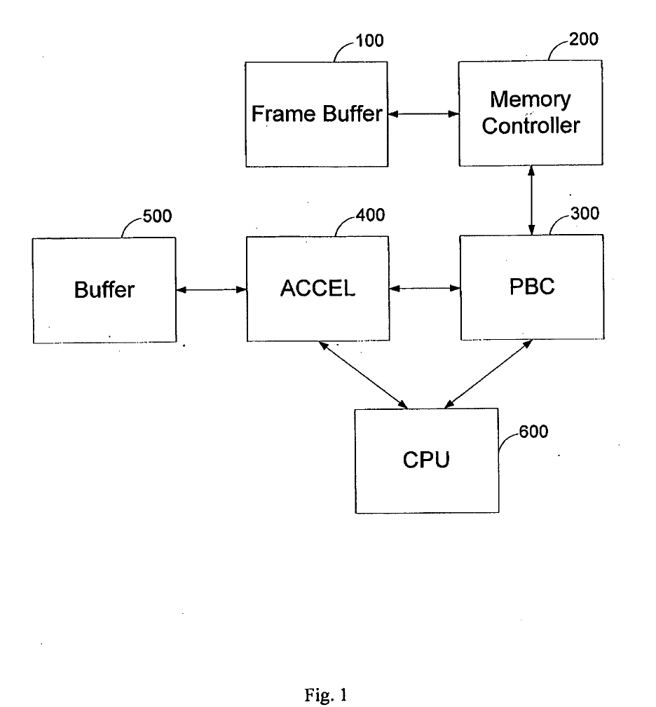

FIG. 1 is a simplified block diagram of a graphics processor according to an embodiment of the invention. The CPU 600, typically being the main processor of the SOC, is responsible, among others, for producing the graphics commands that access pixels of the frame. By access or accessing it is meant to include the operations of reading, writing, altering, shifting, or any other operation regarding the pixels of the frame. As a rule, it is most advantageous to relieve the CPU 600 from basic graphics tasks, as much as possible, in order to free its resources for other tasks such as user interaction. Therefore, the CPU 600 uses Pixel Buffer Cache (PBC) 300 and vector graphics accelerator (ACCEL) 400, for accessing pixels of the frame and for processing basic graphics commands. The PBC 300 is used for accessing one or more pixel(s) or individual color components within the pixel, and the ACCEL 400 is used for processing and accessing a group of related pixels such as a set of pixels depicting a geometrical figure, e.g. a line or a circle. The ACCEL 400 has an auxiliary memory buffer 500 for storing a number of pixel bursts (each burst containing up to 8 pixels). Thus, for example, if the CPU 600 sends a request to the ACCEL 400 to draw a circle, having certain coordinates, the ACCEL 400 breaks the request into basic writing commands for altering the pixel values of the circle. These new pixel values are stored in buffer 500 in their bursts and then sent to PBC 300 in a batch mode, after a sufficient number of them have been aggregated. By batch mode it is meant that the requests are time localized. PBC 300 further aggregates pixel alterations in their bursts and rows and then sends these alterations to memory controller 200. For example, in case the ACCEL 400 issues 8 write commands for each pixel in the same burst, PBC 300 aggregates them into a single command for memory controller 200. Memory controller accesses the requested pixel bursts in the FB 100 and alters the pixel values, in FB 100, as requested. In one embodiment, CPU 600, Pixel Buffer Cache (PBC) 300, vector graphics accelerator (ACCEL) 400, buffer 500 and memory controller 200 are all implemented in a single SOC.

### Memory Arrangement

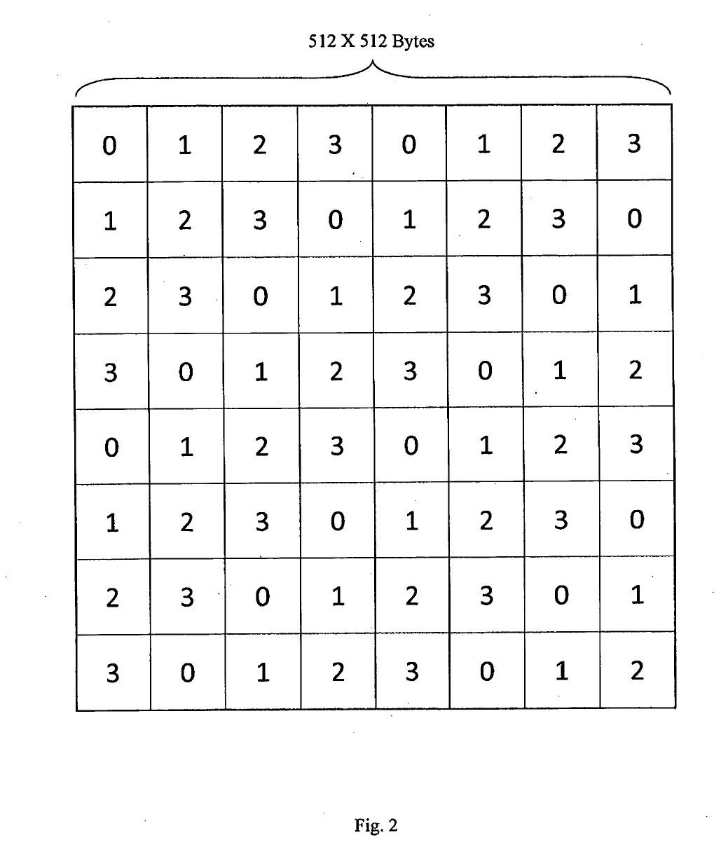

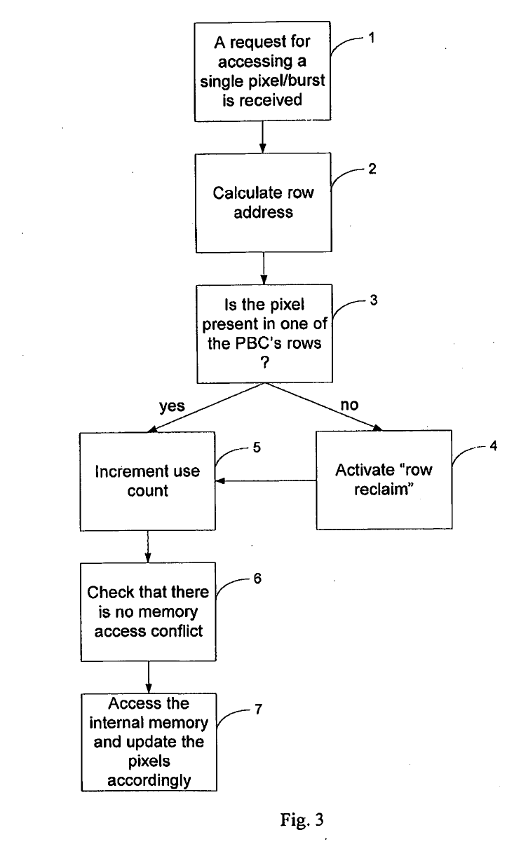

For the sake of brevity the following description deals with the storage of one frame in the FB memory banks, although a number of frames may be stored in the FB, in accordance with the FB capacity and the storage size of the frames, in which case the PBC is capable of tracking these multiple frames simultaneously. The arrangement of the mapping of the FB memory banks is crucial in order to provide fast pixel access for requesting units. For graphics uses it is known that adjacent pixels are more likely to be accessed together, in other words, there is a high degree of spatial locality of reference. Therefore, the following mapping technique is designed to allow fast access to adjacent pixels (horizontal and vertical) while minimizing or eliminating overhead penalty time. The following FB mapping technique also corresponds to the memory addressing attributes. Each row within a memory bank requires an activation/opening sequence prior to accessing the desired pixels and a following precharge/closing sequence. Once a row has been opened, multiple bursts in this row can be accessed without additional overhead. Thus each memory access to a random row requires an overhead penalty that slows the pixels access process dearly. Alas, during the retrieval of pixels from a first bank, other banks may be opened in parallel to data transfer from that first bank, thus minimizing the overhead penalty time. Therefore, when a frame is stored in the FB it is stored in a tiled arrangement in order to diminish the overhead penalty of opening and closing two rows from the same bank. FIG. 2 schematically illustrates an example for the mapping of a frame having 512×512 pixels into 4 FB banks. Each block in the diagram represents a tile and the depicted number represents the bank number to which the tile is mapped. The first tile of the frame (top, left) is stored in FB bank 0, after which the second tile (top, 2 from left) of the frame is stored in bank 1, and so on until the fourth tile (top, 4 from left) of the frame is stored in bank 3 after which the fifth tile (top, 6 from left) of the frame is stored in bank 0. In the second strip, the first tile (2 from top, left) is stored in FB bank 1, after which the second tile (2 from top, 2 from left) of the frame is stored in bank 2, and so on. Thus for both, horizontal and vertical, scanning patterns, banks will be accessed in interleaved fashion allowing to parallelize data transfer with bank activation/precharge operations. For example, if a line is to be drawn starting from left to right (or vice versa), or starting from top to bottom (or vice versa) the sequence of accessed tiles requires opening different banks in an interleaved fashion. For example, drawing a straight line at the top from left to right begins by opening the four banks. Then in the steady state, as soon as the access to the first tile of pixels from bank 0 is finished and the access to bank 1 is initiated, the first row (storing the first tile) in bank 0 is precharged and the second row of bank 0 (storing the top 5^{th} from left tile) is opened. Thus bank 1 is also reopened while bank 2 is read from, and so on. After accessing bank 3, bank 0 can be accessed again as it has been opened already. In this mapping scheme the overhead of row activation/precharge is entirely eliminated for horizontal and vertical lines (as a row contains an equal number of bursts, 8 in this example, in both the horizontal and vertical axis), and in fact for many continuous 2D shape (which can be broken to horizontal and vertical drawing steps), as long as the amount of time spent reading in three banks is larger than the penalty incurred by the memory module for performing a row switch in the same bank.

### Pixel Buffer Cache (PBC)

The PBC is used for aggregating together a number of requests for pixel access in order to save FB access time and to minimize overhead penalty time for pixel access. The PBC comprises a cache of 8 rows which are copies of selected rows from the FB. The PBC is fully associative and its rows may be copies of any rows in the FB. The connected CPU is provided the illusion of dealing with a linear FB, where address conversion is done by the PBC. Therefore the CPU may continue requesting access to pixels of a linear address obliviously of the PBC's conversion and obliviously of the manner of which the frame is really mapped in the FB. The purpose of the PBC is not the same as a standard cache which tries to maximize hit ratio. Rather, the cache purpose is to gather graphics access requests and pass them to the FB for service in an efficient way.

The pixel access requests are localized to a given burst in a given row in order to minimize row activation overhead. The need for such temporal locality is further emphasized for SOC environments with a shared memory. Had the FB been dedicated to the graphics processor, the corresponding row could have been left open after the first request in anticipation for additional accesses, but since the memory is shared with the rest of the units of the SOC, the row is likely be closed shortly after it was opened to allow other units in the SOC to access the memory. The localization in time is done by gathering requests in the PBC prior to submitting them to the FB controller, where the PBC is aware of the FB tiling mapping used for spatial localization. This allows the requests to be serviced using a minimum number of row changes. The PBC, therefore, maintains an internal data structure which is capable of mapping several rows of the frame to internal memories, and keeping track of each burst within those specific rows. Modification of a pixel is first performed in the internal memory and the burst database is updated accordingly, as will be described in relations to FIG. 3. Then, based on several trigger conditions, daemons are activated to flush the data from the internal memories to the FB in quick back-to-back accesses, achieving the desired row thrashing minimization.

In one embodiment, a tile contains (8×8=)64 bursts, and is locally cached in a group of four single port memories (M0-M3), which are also used to store multiple tiles simultaneously tracked by the cache. Each memory address stores a single burst, and burst addresses are interleaved in an arrangement which minimizes contention between the backend transferring data to/from the internal memories to the external frame buffer memory controller, and the frontend transferring data to/from the CPU or ACCEL and the PCB. The following mapping is used from the burst co-ordinate x/y in a row (each addressed from 0-7):

n (memory number)=(x+y) % 4
Mn=the memory which maps the burst.
The address within the memory=x/4+2*y+16*(tile number)
(as each tile occupies 16 inner addresses in each internal memory.)

In this embodiment, data access to/from the FB proceeds at a sequential scan method of y*8+x. If the sequential burst number of a single tile is mapped to the internal memories, it may be shown as follows:

Mem:

| | 0 | 1 | 2 | 3 |
|---|---|---|---|---|
| L00: | 00000 | 00001 | 00002 | 00003 |
| L01: | 00004 | 00005 | 00006 | 00007 |
| L02: | 00011 | 00008 | 00009 | 00010 |
| L03: | 00015 | 00012 | 00013 | 00014 |
| L04: | 00018 | 00019 | 00016 | 00017 |
| L05: | 00022 | 00023 | 00020 | 00021 |
| . . . | | | | |
| . . . | | | | |
| L14: | 00057 | 00058 | 00059 | 00056 |
| L15: | 00061 | 00062 | 00063 | 00060 |

FIG. 3 is a flow chart depicting the process of the PBC for accessing a pixel. At step 1 a request for accessing a single pixel or pixel burst is received. The request for a certain pixel may originate from the CPU in a linear address form, in which case access will be made to a single pixel or a color component within the pixel, or from the connected ACCEL, which is able to access a pixel burst (up to 8 horizontally adjacent pixels) in X/Y coordinates. In step 2 the PBC finds the row address of the requested pixel based on the received pixel address or coordinates. In step 3 the found row address is compared with the addresses of the rows tracked and stored in the PBC. If the required row is not present in the PBC, then in step 4, a “row reclaim” process is activated. In the process of “row reclaim” the PBC finds a row descriptor which can be remapped to the requested tile. The found row descriptor may either be an empty row descriptor, or a row descriptor which can be overwritten. A row descriptor may be overwritten if the tile which it maps does not contain any modified pixels which need to be flushed to the FB and that has no pending read commands. If none is found (no empty row descriptor or a row descriptor that may be overwritten) the reclaim process will block the acceptance of new commands and wait until a row is available, either by syncing with the FB by writing modified contents, or by completing all pending reads, and then reuse the descriptor. The following steps are relevant only for modifying a pixel. In step 5 the use count of the required row is incremented so the system would know how many commands are still using that row. In addition, the system can mark which of the pixels is modified by updating a map of “dirty” bits, where every bit maps a pixel, and the modified pixel's corresponding bit is signaled as “dirty”. In step 6 the system awaits until there are no access conflicts on the local cache memory by the parallel reads/writes of other data mapped to the same local memory from/to the FB, and once the local memory is free, in step 7, the PBC accesses the internal memory and updates the pixels, and updates the corresponding “dirty” bits.

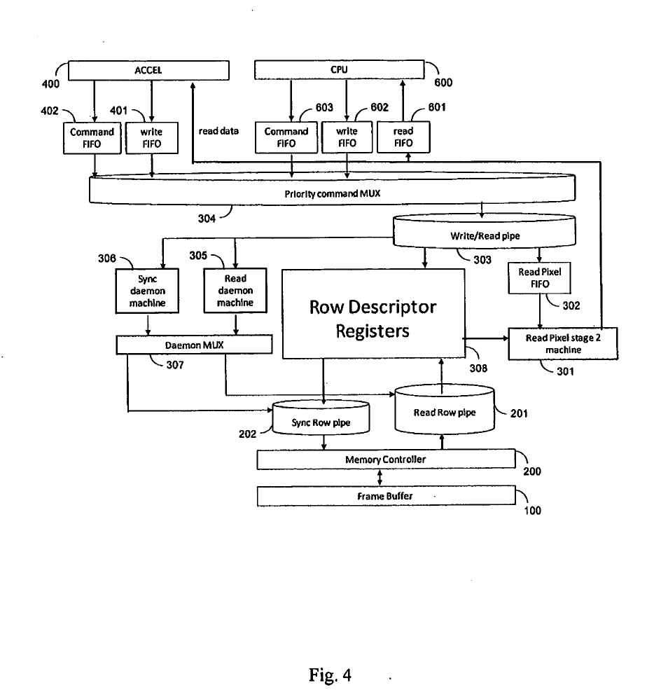

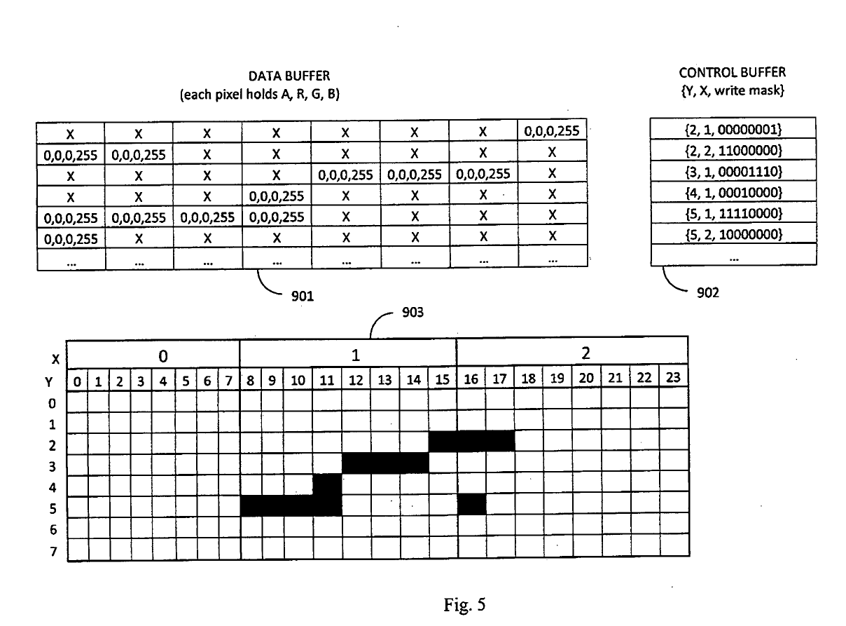

FIG. 4 is a block diagram of the inner parts of the PBC. As described in relations to FIG. 1, the requests for accessing a pixel may originate from the CPU 600 or from ACCEL 400. The CPU 600 sends his commands through Command FIFO 603. The pixel modification data is sent through write FIFO 602 and the pixel data requested for reading is retrieved through read FIFO 601. ACCEL sends his commands through Command FIFO 402, and the pixel modification data is sent through write FIFO 401. All these commands and pixel data are received by priority command MUX 304, who decides the order of the commands based on preset rules. The commands and data are then sent to write/read pipe 303. The write commands and their data are received by row descriptor registers 308 which perform the process described in relations to FIG. 3. The read commands are processed similarly in the row descriptor registers 308 as described in relations to FIG. 3, and copied to read pixel FIFO 302. The read daemon machine 305 is in charge of handling the rows with read commands in the row descriptor registers 308. Each row's read commands may be serviced according to preset rules, such as the number of reads request in that row, the time elapsed from the first read request, etc. The read command is sent to Daemon MUX 307 which sends the read command to row descriptor registers 308, through read row pipe 201. When the read daemon machine 305 handles the read commands of a certain row the requested bursts of the row are sent to read pixel stage 2 machine 301. At this point the read pixel stage 2 machine 301 erases the read commands from read pixel FIFO 302 corresponding to the received bursts. The received bursts are then sent to the unit which requested them. The Sync daemon machine 306 is in charge of flushing the rows with write commands, i.e. rows that have been modified, in the row descriptor registers 308. Each row may be flushed according to preset rules, such as the number of modifications in that row, the time elapsed from the first modification, etc. The flushing command is sent to Daemon MUX 307 which sends the flushing command to row descriptor registers 308, and sync row pipe 202. Then the row descriptor registers 308 sends the commanded modified bursts and their data to memory controller 200 through sync row pipe 202. The memory controller 200 updates the FB 100 accordingly.

### Vector Graphics Accelerator (ACCEL)

### Line Buffers

In one embodiment, ACCEL utilizes several line buffers, each internally composed of 9 memories, 8 for mapping 8 pixels of an aligned burst (corresponding to a burst storage in the external frame buffer), and another control memory, storing the x/y co-ordinates of the burst, as well as a mask specifying which pixels within the burst are of interest.

The line buffers are a common resource used by ACCEL's DMA machines and MCU, both described next.

### DMA Machines

The purpose of Direct Memory Access (DMA) machines is to facilitate efficient data flow into and out of a processor, and to parallelize the operation of data transfer with processing of additional independent data.

A lot of the information required to be processed by the ACCEL is present in the FB. For example, when the ACCEL is given an instruction by the host CPU to draw a rectangle using a solid color onto the visible screen, it is actually required to write the solid color value into a series of addresses in the FB. In another typical example, the ACCEL is required to copy one area of the FB into another, while creating a blending effect between the new values being copied and the old values already present at the destination. In this second more complex example, the ACCEL has to read the values from the source area, read the old values from the destination area, calculate the blended values, and finally write these blended values back into the destination area in the FB.

Without an efficient high-bandwidth solution to bring in and send out data between the ACCEL and the FB, high graphics performance would not be achieved.

An embodiment of the present invention includes the following DMA machine implementations:
Read non-aligned—allows the ACCEL to read a linear segment of pixels from a FB plain. The segment may start at non burst-aligned horizontal address, and may stretch a width which is not an integer amount of bursts. The transfer is implemented by the machine via grouping of bursts and automatic generation of write masks for these bursts, in turn allowing use of the PCB interface as described at burst aligned addresses. The concept of a segment here is broadened to the respect that when the last pixel in the plain is reached, wrap around occurs and the following pixels read from the FB plain are the first pixels in the next row (y+1). The destination to which data read from the FB is written is the buffer 600 described in relations to FIG. 1.
Write non-aligned—similar to the previous machine, but in the reverse direction.
Read aligned—reads a series of aligned bursts, each with its own coordinates from a FB plane, into the buffer 500.
Write aligned—similar to the previous machine, but in the reverse direction.

The line buffer, having 8 memories each storing a single pixel, allows the DMA machines in non aligned mode to be used for efficient copying of data regardless of the source and target burst alignment. For example, if the line buffer stores a line of the frame buffer starting from pixel 0. Then, to access pixels 0-7 in the line simultaneously as a single burst, we can read address 0 in the eight data memories. In the same manner we can also access pixels 1-8 which are not burst aligned by reading address 0 in data memories 1-7, but address 1 in data memory 0, in the same clock cycle.

The 9'th control memory, allows calculation in advance of the geometry co-ordinates of various shapes, which gives two useful features: first is providing a temporal locality of access to the PCB, and eventually the FB, minimizing system memory bandwidth usage by grouping the requests. Second, we can perform several operations on the pixels described by those co-ordinates without having to recalculate the co-ordinates. For example, we can calculate the co-ordinates of a line once, set up the control memory, operate the aligned-mode DMA machine to bring the pixels of those lines, perform some blending operation on them in the ACCEL, then readily write them back to their original locations also with an aligned-mode DMA, as the control memory is already set up.

FIG. 5 depicts an example of the write aligned implementation. In this example the coordinates, of a certain shape shown in table 903, are calculated in the ACCEL. The calculated coordinates and their respective coloring are updated in the Data Buffer. The depicted table 901 which depicts a portion of the Data Buffer shows how each strip stores 1 burst which is 8 pixels, and each pixel stores 4 Bytes known as ARGB (Alpha Red Green and Blue). In this example the certain shape is drawn in blue thus in all the updated pixels only the blue has a value of 255. Together with updating the pixels data in the Data Buffer, the ACCEL also updates the Control Buffer which indicates the amended pixels. Table 902 depicts a portion of the Control Buffer. Each strip in table 902 indicates the X/Y coordinates and the write mask of the burst. For example, the first strip in table 902 indicates that in the burst of coordinates Y=2 and X=1, the left most pixel has been amended, and so on. Thus all the amendments are stored in the Control Buffer until the DMA machine copies this information to the PBC. In one embodiment more assisting information is stored in the Control Buffer. In one embodiment the X coordinates

### Rasterization Acceleration Machines

In order to expedite the execution of graphics instructions from the host CPU which are of the form “draw a graphical object to the FB”, a plurality of special hardware machines are implemented in a preferred embodiment of the present invention. Each machine is responsible of accelerating a common graphics primitive which needs to be drawn (also termed “rendered” or “rasterized”) to the FB.

One embodiment of the present invention implements a thin line rasterization machine. The machine uses an algorithm for zero-point line rasterization which has high precision such as the midpoint algorithm, Bresenham's algorithm, or a Digital Differential Analyzer (DDA)—all known methods in the art. This machine receives from the processor a structure which describes the line requested (e.g. by supplying the FB plane on which drawing is desired, and the horizontal and vertical coordinates of the pixels which make up the endpoints of the line), the solid color or pattern of the line and more.

The machine then populates a buffer memory with the burst control information and data. When the buffer is full or when all the bursts affected by the line being rasterized have been processed, the machine automatically activates an aligned mode DMA write of the data, to efficiently store the populated bursts into the FB plane. Optionally, the automatic activation of the DMA is gated, and the ACCEL may intervene in order to add more complex effects before writing the data to the FB, such as read the data already present at the affected bursts in order to create a blending effect of old and new values.

If required, additional logic in the machine clips the line primitive against a clipping rectangle, to support rasterizing the line only inside a window on the FB plane (functionality required by many graphical software libraries). The algorithm employed by the clipping logic may use the Cohen-Sutherland algorithm known in the art for efficient clipping, or a brute-force method in which all pixels are processed but only those within the clipping rectangle are actually written to the FB, or a combination of both methods.

Other embodiments of the present invention may implement additional rasterization acceleration machines for primitives such as but not limited to wide lines, rectangles, triangles, arcs, circles and ellipses, convex and concave general polygons with a plurality of effects.

### MCU

The MCU is the main processing unit of the ACCEL.

The MCU is a programmable micro-controller, comprising a pipelined controller, one or more arithmetic-logic units, one or more register files, one or more instruction and data memories, and additional components.

In a preferred embodiment of the present invention, the MCU processor has access to three general purpose register (GPR) file types: fixed point scalar (general registers), fixed point vector (graphics registers) and vector floating point (floating point registers).

Preferably fixed point scalar registers are used for supporting control calculations i.e. the location at which to draw a graphical object according to a host command. To be able to do this effectively a preferred embodiment would use 32 bits of data per register, and have at least 16 such registers. These registers are readily used as operands in standard arithmetic and logical operations.

During usual operation of a preferred embodiment of the present invention, the graphics registers are used as the main carriers of graphical data being currently processed. Each register is divided into pixel accumulators and each pixel accumulator is further divided into color component accumulators.

In a preferred embodiment, each pixel accumulator has four color component accumulators. Color component accumulators would normally require at least 8 bit of accuracy to faithfully carry a color component in a modern system. For further accuracy during complex algorithms a width of 16 or even 32 bits per component is beneficial. Having multiple pixel accumulators in one graphics register and allowing ALU and control SIMD (Single Instruction Multiple Data) operations on the entire register allows the processor increased throughput (pixels processed per clock) up to the point where the full underlying memory architecture bandwidth is reached. The count of pixel accumulators in a graphics register can grow to 8 and more and still produce effective parallelism in one preferred embodiment.

The floating point registers are dually used—first as another means of calculating control data and second for data storage of currently processed graphics properties. The difference between the fixed point and floating point vector register files is that while floating point calculations are generally slower and, in the common range, less accurate than their fixed point counterparts, floating point calculations can be done in a very high dynamic range required by perspective transforms, lighting calculation and other operations commonplace in graphics systems, and especially in 3D graphics engines.

One embodiment of the present invention implements the floating point industry standard IEEE 754 (interpretation of stored register bits and operations available on these registers in the ALU). In one such embodiment the vector elements are single precision IEEE floating point numbers which are 32 bits wide, and each vector is made of 4 or 8 elements on which SIMD instructions are available in the MCU.

The basic IEEE floating point operations are add/subtract, multiply, conversions to/from integer, arithmetic relation (equal, less or greater than, etc.), and fractional/integral part extraction. These operations allow for virtually any arithmetic calculation, but although much more complicated to implement with respect to their integer counterparts these operations are still insufficient for many high speed calculations common in graphics processing and specifically in 3D graphics processing.

For example, a perspective division is usually required in one step of the popular real time 3D graphics pipeline used by many graphics environments including most video games. While it is possible to calculate exactly or to approximate (to a desired degree) a division operation with the basic floating point operations, to do so would be prohibitively time consuming because the methods available require complex calculations with serial data dependency (i.e. polynomial approximations which require high order multiplications and many additions).

With the insight that in most situations encountered in graphics processing the actual amount of precision is close but not the full precision achievable in floating point numbers the ACCEL further implements an advanced floating point approximation unit. This module approximates the following floating point operations widely used in graphical calculations: reciprocal, square root, reciprocal square root, natural logarithm, natural exponent, sine, and cosine.

Reciprocal, square root and reciprocal square root are separable (multiplicatively) with respect to the representation of IEEE 754 floating point numbers {sign, exponent, and mantissa} which makes these functions natural candidates for table based methods of approximation. An embodiment of the present invention uses tables with at least 256 entries approximating the separate functional result on the mantissa, to which access is made from reduction into the at least 8 MSBs of the operand's mantissa. The sign and exponent separable results are calculated arithmetically, and during a final reconstruction phase, the separable parts are combined to an IEEE float, with possible special cases taken into consideration.

For example, consider the floating point operand f={s, e, m} denoting the real number {(−1)̂s*2̂(e−128)*1.m} where <s> is a single bit representing the sign, <e> is an eight bit number for the biased exponent, and <m> a 22 bit normalized mantissa with a hidden leading ‘1’ bit as IEEE 754 single precision defines. In order to approximate the reciprocal square roots:

1. The sign must be positive (‘0’) otherwise it's a special case which shall be treated in the reconstruction phase with a proper exception.
2. The exponent can be calculated separably since 1/sqrt(f)=1/sqrt({(−1)̂s*2̂(e−128)*1.m)=1/sqrt(2̂(e−128))*1/sqrt(1.m) and the exponent part is readily 2̂(0.5*(128−e)). The processor further uses the LSB of <e> to detect leakage of exponent losing precision due to the 0.5* operation, and multiplies the mantissa accordingly.
3. The mantissa has to be approximated since 1/(1.m) in 23 bits is too difficult to compute both accurately and quickly. Therefore the high 8 bits of <m> are used as an index into an approximation table for this value.
4. To reconstruct the final result one simply has to concatenate the new sign, exponent and mantissa calculated in 1, 2, 3 respectively. In some special cases, this result is overruled—like in the case where the operand's original sign <s> was negative—in which case the standard NaN value needs to be returned, and a proper exception flag raised.
5. Additional phases of higher order refinement might be now employed by the processor to further increase result accuracy up to the full precision available if necessary. For example, the Newton-Raphson algorithm starting with a good initial estimate such as the result provided by the initial approximation from the table based method in stages 1-4 can read full singe precision IEEE floating point for the said function from in up to three iterations. Implementation of the algorithm requires only multiplications and additions, which are available in the basic floating point unit of the processor.

Logarithm, exponent and the trigonometric functions do not display the same multiplicative separability seen in the previous three functions. However, the logarithm function still lends itself to separable table based approximation methods in the following way. log({(−1)̂s*2̂(e−128)*1.m)=log(2̂(e−128))+log(1.m) which means one may calculate a logarithm using approximation or direct calculation of more constrained logarithms, and then add the results to obtain a final value.

Sine and cosine functions are also approximated using a reduction, table access and reconstruction method. During the reduction phase, a special instruction in the processor calculates the operand's fractional and integral components with respect to one quarter of the function period: x=N*pi/2+r. N is then used to invert the final result's sign and/or complement the index used in accessing the approximation table. The baseline index is taken from the integer term round(r/(pi/2)*<table size>). In the reconstruction phase, the final sign is calculated from the table and the proper quarter (N modulo 4), and the absolute value taken form the table.

A selected minimal group of instructions allow moving and converting data between register set files. The reason these instructions are made minimal is to simplify connectivity logic and to avoid creating unnecessary relations in hardware. A programmer of the processor's firmware may move data between every two register files as is (bitwise data copy) or if one group is floating point conversion from integer to floating point or from floating point to integer can be requested.

In an embodiment, the MCU has access to any of several memories: instruction cache, data cache, general memory, DMA memory, one or more command FIFOs, an additional register file (special registers) and one or more buffers. The instruction and data caches serve to efficiently access the large pool of possible code and data information as known in the art.

In an embodiment the Instruction Cache IC uses a long instruction word (of at least 64 bits) which allows for more complex DSP instructions to be issues per clock. The IC produces one instruction per cycle on cache hits (where the instruction address requested in present in the physical memories of the cache). IC architectural parameters such as the block size (also termed cache line) and the level of associatively are tailored to fit graphics processing code as statistically observed over a large code-base. Typically a two-way set associative cache with 16 word blocks is a suitable choice.

In another embodiment two data caches are used, one is scalar oriented and of 32 bit words used for general purpose (i.e. a large data stack), the other is vector oriented with at least 128 bit words, and can be used for tile caching, sprite caching, palette information, and in many graphics related algorithms which require a large memory bank with spatial and/or temporal locality of reference properties (i.e. z-buffering in some situations, some shadow and lighting models etc'). The DC architectural parameters are tailored out of statistical inference similarly to those in the processor's IC. It is usually beneficial to employ four-way set associative data caches with four word blocks.

The general memory is usually used for persistent global variable storage, a short data stack for local automatic temporary data storage, and for Communication via the Switch interface CS. The DMA memory is commonly used for the same purposes as the general memory, but also for direct memory access into a very large (albeit usually slow) memory bank. This DMA memory may also be seen as a general purpose firmware-managed data cache, fetching or releasing data at the merit of processor programs.

The command FIFOs are the same memories described in connection with the host CPU interface. The MCU reads data from the FIFOs, processes and executes the requests given by one of the hosts. In an embodiment the data FIFOs are actually one with the described buffers.

The special register file is used for direct access into configuration and control signals present throughout the graphics processor. One example for special register file usage would be to activate or deactivate the entire processor with the signal “run enable”. The GPRs also double as special registers.

The buffer memories serve as the main temporary storage for blocks of information being currently processed by the processor. Since the sources of data effecting the processing of graphical objects are usually located in a large FB memory with known access properties (slow random access, but high transfer bandwidth), it is beneficial to copy a large amount of data at a time into the processor's fast random access memory which is the buffer. In order to efficiently support raster oriented algorithms, where a complete display line is processed at a time, this memory needs to include at least the amount of data required to represent one (or preferably two and even four) lines of visual graphical data in the FB.

In one embodiment, two or more buffers may be used to achieve a better efficiency. For example while a line is being processed the next line can be fetched from the FB to save time overall instead of performing the two steps serially.

A buffer, in one embodiment, is actually made up of a plurality of semiconductor memories: a group of data memories and one control memory. Each data memory address holds a piece of a burst (e.g. one 32 bit pixel). Concatenating the words from all data memories at an address makes up one whole burst. The corresponding address in the control memory may hold extra information about the burst useful in DMA or processing operations. The control memory has fields for burst horizontal and vertical position, as well as write mask on a pixel basis. For example, in one embodiment 256 bit bursts are used, where each pixel is a full 32 bit true color pixel (pixels themselves are quads of four color components each held at 8 bits of precision: red, green, blue, and alpha channel which is used for compositing). In this case a burst is eight pixels. There are eight data memories, each holding one 32 bit pixel, and one control memory holding 13 bit vertical (y) position for the burst, 10 bit horizontal position for the burst (x of the first pixel in the burst, divided by 8 pixels per burst) and an eight bit write mask which is ‘0’/‘1’ to mark the corresponding pixel write/processing should be masked/unmasked respectively.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the invention or exceeding the scope of claims.

1. A system for providing a high bandwidth memory access to a graphics processor comprising:
a. a frame buffer for storing at least one frame, where said frame is stored in a tiled manner;
b. a memory controller for controlling said frame buffer;
c. a pixel buffer cache for storing multiple sections of at least one memory row of said frame buffer, and for processing requests to access pixels of said frame buffer;
d. a graphics accelerator having an interface to said pixel buffer cache for processing a group of related pixels; and
e. a CPU for processing graphic commands and controlling said graphics accelerator and said pixel buffer cache.

2. A system according to claim 1, where the pixel buffer cache comprises at least one row descriptor for tracking and monitoring the activities of read and write requests of a particular tile.

3. A system according to claim 1, where the pixel buffer cache comprises an internal memory which can store at least one tile.

4. A system according to claim 3, where the pixel buffer cache comprises at least one read daemon which reads pixels from the frame buffer and writes them into the internal memory.

5. A system according to claim 3, where the pixel buffer cache comprises at least one sync daemon which finds the modified pixels in the internal memory and writes them into the frame buffer.

6. A system according to claim 1, where the graphics accelerator contains one or more line buffers for storing pixels.

7. A system according to claim 6, where each line buffer contains pixel memories and a control memory.

8. A system according to claim 6, where the graphics accelerator contains at least one DMA machine which transfers data between the line buffers and the pixel buffer cache.

9. A system according to claim 1, where the graphics accelerator contains a programmable micro-control unit.

10. A system according to claim 9, where the programmable micro-control unit performs vector graphics operations.

11. A system according to claim 1, where the graphics accelerator contains dedicated hardware for line drawing.

12. A method for optimizing memory bandwidth to a graphics processor comprising the steps of:
a. receiving a request for rendering a geometric object;
b. dividing said request for geometric object into multiple burst requests;
c. transferring said burst requests to the pixel buffer cache;
d. calculating the address of the row of said pixel;
e. checking if said row is present in the pixel buffer cache;
activating row reclaim process if said row is not present in said pixel buffer cache; and
g. activating at least one daemon for transferring data between the internal memories of said pixel buffer cache and the frame buffer.
